(19) United States
(12) Patent Application Publication
(10) Pub. No.: US 2005/0240583 A1
(43) Pub. Date: Oct. 27, 2005

(54) Literature pipeline

(76) Inventors: Peter W. Li, Brookeville, MD (US); Mark D. Yandell, El Cerrito, CA (US); William Majoros, Germantown, MD (US); Michael A. Harris, Silver Spring, MD (US); Rui Ru Ji, Princeton, NJ (US); Kendra Biddick, Clarksburg, MD (US); Gangadharan M. Subramanian, Ellicott City, MD (US); Jian Wang, S. Grafton, MD (US)

Correspondence Address: HARNESS, DICKEY & PIERCE, P.L.C., P.O. BOX 828, BLOOMFIELD HILLS, MI, 48303, US

(21) Appl. No.: 10/996,819

(22) Filed: Nov. 23, 2004

Related U.S. Application Data
(63) Continuation of application No. 10/762,229, filed on Jan. 21, 2004, now abandoned.

(51) Int. Cl. G06F 17/30

(52) U.S. Cl. 707/7

(57) ABSTRACT

A literature pipeline corresponds to a document navigation system having a datastore of direct links between pre-defined core concepts found in a document corpus. A link identification module identifies indirect links between core concepts selected by a user based on connection of direct links through at least one core concept not selected by the user. An output communicates identified links to the user.

### CROSS-REFERENCE TO RELATED APPLICATIONS

This application is a continuation of U.S. patent application Ser. No. 10/762,229 filed on Jan. 21, 2004. The disclosure of the above application is incorporated herein by reference.

### FIELD

The present disclosure generally relates to information retrieval and document navigation systems and methods, and relates in particular to automatic identification of indirect links between discipline-focused core concepts found in a document corpus.

### BACKGROUND

Information retrieval and document navigation systems provide users access to literature in a variety of ways. This variety of approaches results in part from the many attempted solutions to the difficult problems of helping users to assemble, navigate, and understand documents relating to points of interest in a particular research discipline or field of study. For example, previous work has explored word-based search engines and concept indexing with curated concept synonym lists, lexica, and ontologies. Additional previous work has explored preprocessing and post-processing techniques such as stemming, query expansion, dimensional reduction, relevance feedback, query result clustering, and abstract summarization. Further previous work has explored query result visualization in the form of starfields, citation networks, and self-organized maps. Yet further previous work has explored co-occurrence detection with considerations of granularity, statistical filtering, and automatic construction of thesauri. Still further previous work has explored information extraction procedures employing hand-crafted templates, syntactical parsing, anaphora/cataphora resolution, inference extraction, negation handling, and word sense disambiguation. Finally, previous work has explored use of lexica, thesauri, and ontologies, with much attention given to semantic networks resulting from automatic ontology construction based on terminology extraction performed on document contents.

Given the variety of tools available for performing information retrieval and document navigation, one might conclude that users should have little trouble in locating, navigating, and understanding information contained in a literature corpus. Difficulties, nevertheless, plague users attempting to mine information in a vast literature corpus, and these difficulties may be readily observed with respect to the activity of biomedical literature mining. For example, the biomedical literature corpus commonly made available to users via information retrieval and document navigation systems includes documents written by and/or for practitioners of diverse research disciplines. As a result, researchers of different disciplines performing related research may publish highly related results utilizing vastly dissimilar terminology. Thus, it is difficult for a user of a particular research discipline, such as a gene/protein discipline, to anticipate the terminology of other disciplines, such as disease, drug, tissue, and taxonomy related disciplines. Also, even where recent advances in semantic parsing have made it possible to identify direct links between research related concepts, a user exploring these links must identify each concept of interest, and may obtain only direct links between the specified concepts that are expressly identified in the literature. As a result, a user must anticipate potential direct links between core concepts, and must further infer existence of indirect links between concepts by assembling direct links identified in a laborious manner. The need to anticipate each link and make inferences across disciplines, when combined with variations in terminology between disciplines, makes the task of mining biomedical literature and other bodies of literature in a meaningful way both difficult and laborious.

The need remains for an information retrieval and document navigation system and method that accommodates variations in terminology across disciplines. The need further remains for such a system that assists a user in finding indirect links between concepts without requiring the user to anticipate and specify each potential direct link. The information retrieval and document navigation system and method disclosed herein fulfills this need.

### SUMMARY

A literature pipeline corresponds to an information retrieval and document navigation system having a datastore of direct links between pre-defined core concepts found in a document corpus. A link identification module identifies indirect links between core concepts selected by a user based on connection of direct links through at least one core concept not selected by the user. An output communicates identified links to the user.

Further areas of applicability of the literature pipeline will become apparent from the detailed description provided hereinafter. It should be understood that the detailed description and specific examples are intended for purposes of illustration.

### BRIEF DESCRIPTION OF THE DRAWINGS

The literature pipeline will become more fully understood from the detailed description and the accompanying drawings, wherein:

FIG. 1 is a functional block diagram illustrating an information retrieval and document navigation system;

FIG. 2 is a block diagram illustrating multiple, discipline-focused lexica;

FIG. 3 is an entity-relationship diagram illustrating a datastore recording direct links between core concepts of multiple, discipline-focused lexica, and maintaining pointers to document contents supporting the direct links;

FIG. 4 is a block diagram illustrating user-interface modules providing user input and system output functionality;

FIG. 5 is a block diagram illustrating indirect link identification and visualization modules facilitating user understanding of relationships between core concepts in a literature corpus;

FIG. 6 is a block diagram illustrating bounding node dependency of potential relationships for direct links between core concepts;

FIG. 7 is a block diagram illustrating constraint lists of candidate relationships between bounding nodes of various types;

FIG. 8 is a block diagram illustrating hyperlink functionality of visually rendered graph components; and

FIG. 9 is a flow diagram illustrating a method of information retrieval and document navigation.

### DETAILED DESCRIPTION

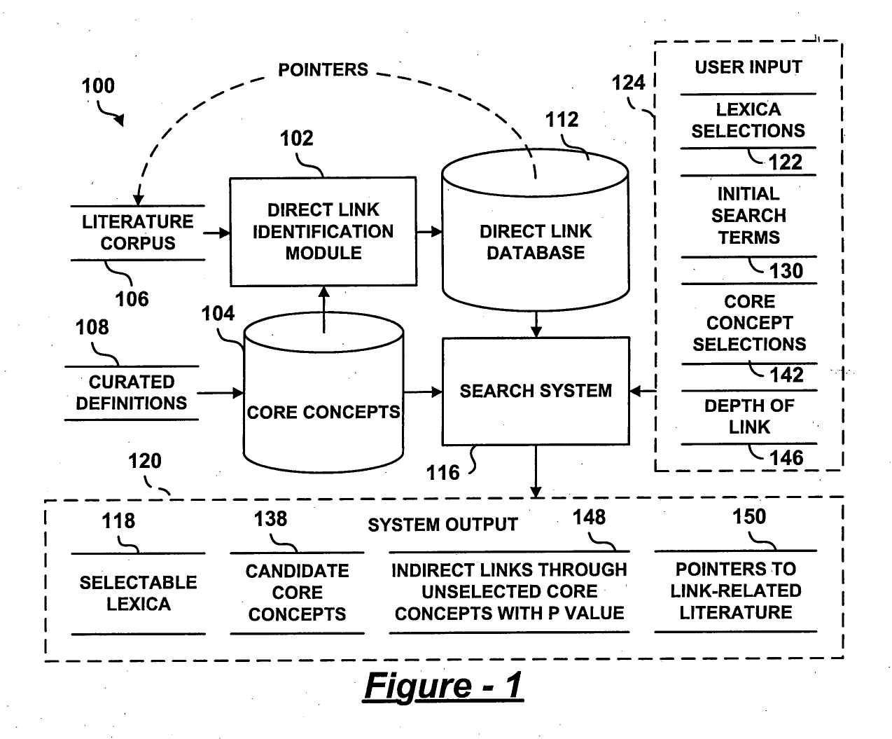

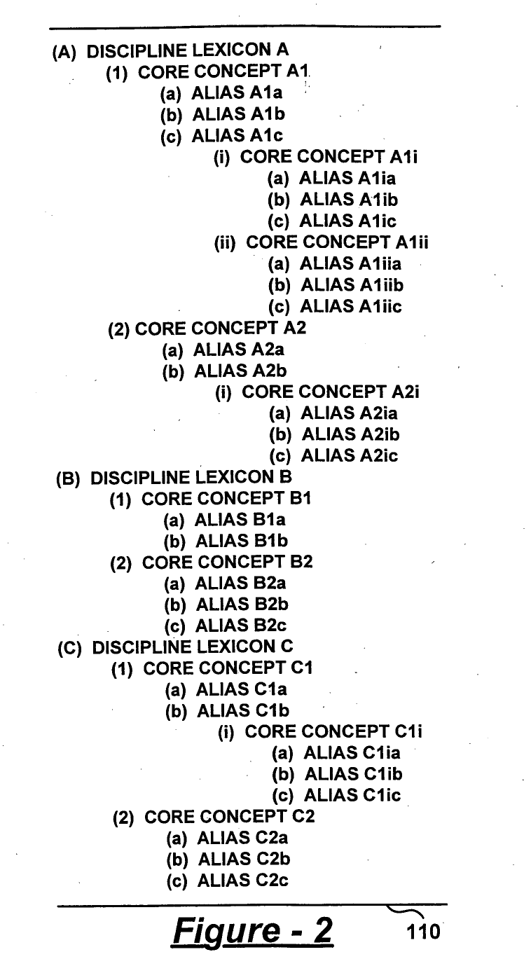

Referring to FIG. 1, the information retrieval and document navigation system 100 employs a direct link identification module 102 to find direct links between core concepts 104 in literature corpus 106. In some embodiments, core concepts 104 as illustrated in FIG. 2 correspond to multiple, discipline-focused lexica 110, each appropriately ontologically organized according to their respective disciplines. It should be readily understood that lexica are treated as a super-class of ontologies, which are lexica hierarchically organized according to super-class and sub-class related classification schema. In some embodiments, one or more of the lexica may be organized according to biological function, such as molecular function and/or biological process, with pointers to documents and/or data, such as gene and/or protein sequence data. In one example, the lexica may organize families and subfamilies of multiple alignments of protein sequences according to biological function. These lexica may be browsable, such that users can learn about core concepts and relationships between concepts, and users may select core concepts as needed and as further explained below.

Multiple aliases are provided for each core concept, and these aliases include variously employed names for the concept in the form of single words and multi-word phrases. It is also envisioned that aliases may take the form of Boolean queries and semantic templates. For example, module 102 (FIG. 1) may be adapted to look for a stemmed alias in document contents. Also, module 102 may be adapted to look for an alias in a specified degree of proximity to one or more other words. Further, logical negations may be employed to reduce confusability. Thus, an alias for a gene may correspond to a Boolean query of the form (white AND !(/5 (labcoat$ OR blood cell$))). This query may operate to locate an occurrence in a document of the word “white”, but not within five words of “labcoat” or “labcoats”, and not within five words of the phrases “blood cell” or “blood cells”. Curated definitions 108 are preferably employed to construct and maintain the lexica for purposes of quality and reliability. It should be readily understood, however, that such lexica may equivalently be generated automatically, especially in the case of future advances in automatic generation of thesauri, lexica, and/or ontologies.

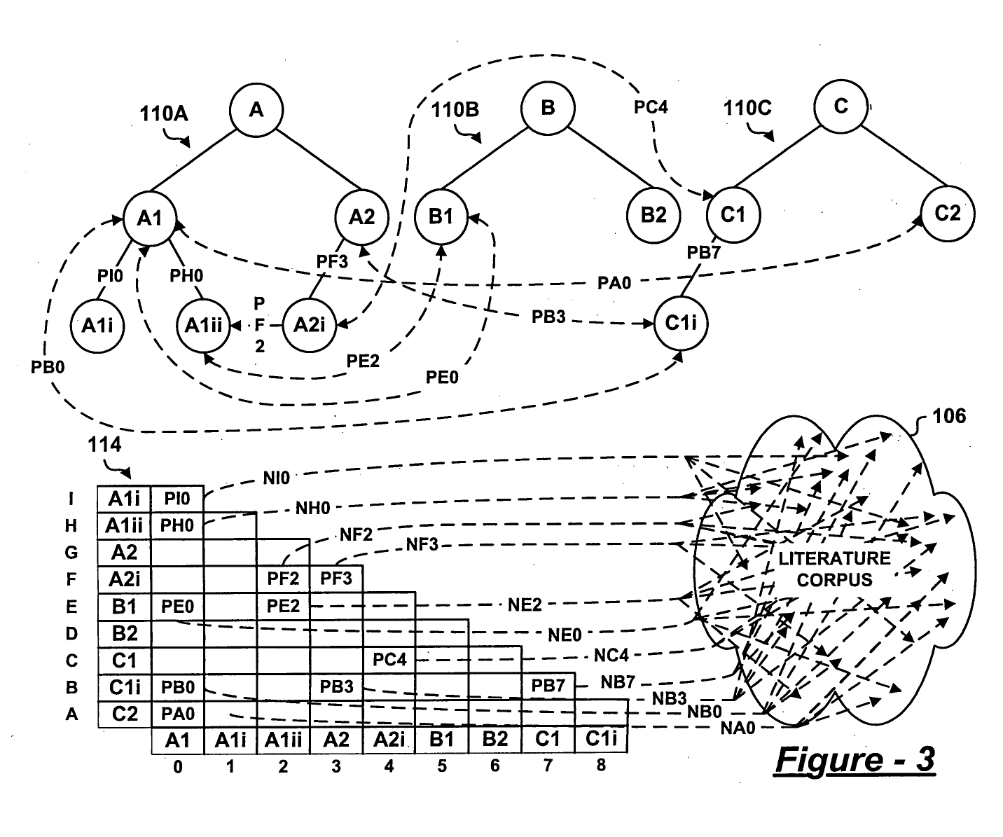

Direct link identification module 102 finds direct links in literature corpus 106 by examining document contents. The found links are stored in direct link datastore 112, and pointers from direct links to documents that support the direct links are recorded in association with the corresponding direct links. In some embodiments, module 102 employs co-occurrence detection to find the direct links based on detected co-occurrence of core concepts 104 in document contents of literature corpus 106. Accordingly, module 102 may initially identify occurrences of each core concept 104 in literature corpus 106 and generate a matrix relating core concepts to core concepts in datastore 112. Pointers from each core concept to locations in document contents in which the core concepts are located may also be recorded, such that each row and each column of the matrix may have a set of pointers for the related concept. Then, as illustrated in FIG. 3, pointers to identical documents that are commonly positioned along both axes of the matrix where rows and column intersect may be grouped together as pointer groups NA0, NB0, NB3, NB7, NC4, NE0, NE2, NF2, NF3, NH0, and Ni0. Pointers of these groups may accordingly point from respective cells of matrix 114 to documents of literature corpus 106 in which the co-occurring core concepts found in the specific row and column of matrix 114 co-occur. As a result, co-occurrences of core concepts may be detected in the indicated documents, and direct links may be initially identified. Then, module 102 (FIG. 1) may employ a mutual information technique such as the Fisher exact test with respect to the indicated documents for each direct link to determine statistical significance of the detected co-occurrences. Other types of mutual information techniques, such as the log likelihood ratio or Pearson's Chi-Squared test, may alternatively be employed in accordance with the present invention. It should be noted, however, that Fisher's exact test is a significance test that is considered to be more appropriate for sparse and skewed samples of data than these other mutual information techniques. The P values indicating relative strength of significance may be recorded in cells of matrix 114 (FIG. 3) as direct links PA0, PB0, PB3, PB7, PC4, PE0, PE2, PF2, PF3, PH0, and PI0. Further, a threshold respective of the P value may be employed to discard direct links of low significance.

As may be readily appreciated by one skilled in the art, multiple, discipline-focused lexica 110 (FIG. 2) may be viewed as directed, acyclic graphs 110A, 110B, and 110C (FIG. 3). Accordingly, direct links between nodes may be viewed as edges of the graphs where these links follow the ontological organization of the respective lexica. It should be readily understood that direct links embodied in ontological organization resulting from curation are conceptually distinguishable from direct links that may be automatically formed based, for example, on detected co-occurrence. It may reasonably be expected, however, that co-occurrence is likely to be detected between core concepts that are hierarchically related in the ontology, and that such automatically detected links may be caused to overlay preexisting curated links on a conceptual basis. Such links are exemplified at lexical graph edges PB7, PF3, PH0, and PI0. Otherwise, automatically detected direct links may be viewed as threads between nodes as with links PA0, PB0, PB3, PC4, PE0, PE2, and PF2. The resulting threaded graph structure may reside in datastore 112 (FIG. 1), and may have edges that include lexical graph edges and threads. Pointers from edges of the threaded graph structure may be maintained to documents containing information about how the concepts are linked together. It is envisioned that the direct links may be found by techniques equivalent to co-occurrence detection, such as semantic parsing.

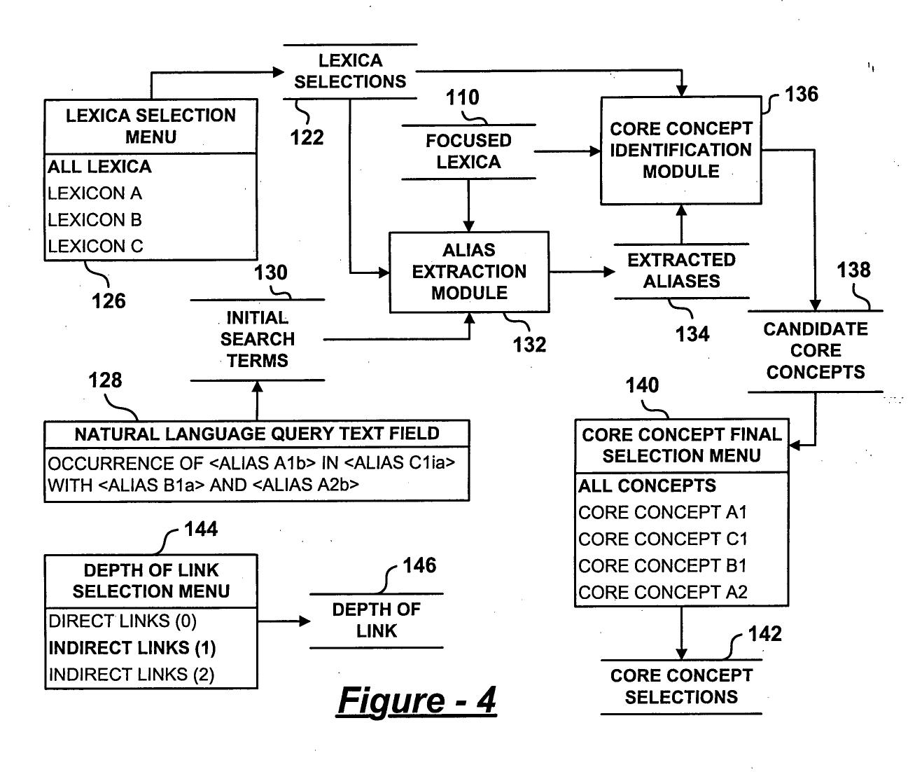

With datastore 112 recording direct links between core concepts 104 and maintaining pointers to locations of documents in the literature corpus, locations of portions of documents, such as abstracts, and/or locations in document contents containing information that support formulation of the direct links, the task remains to facilitate user access to the assembled information and related document contents in a meaningful manner. The literature pipeline accomplishes this task by providing portions of the threaded graph structure to users based on user-specified edge nodes and a depth of link for connecting direct links through shared, internal nodes. This functionality is provided by search system 116. Accordingly, search system 116 communicates selectable lexica 118 to users as system output 120, and receives lexica selections 122 from users as user input 124. FIG. 4 illustrates a lexicon selection module 126 of a user interface of the system that allows users to make lexica selections 122. An input module 128 further allows users to enter initial search terms 130. For example, a user may be permitted to enter a natural language query containing various aliases for core concepts, and alias extraction module 132 may therefore generate extracted aliases 134 based on the initial search terms 130 and lexica 110 specified by lexica selections 122. Also, it is envisioned that a user may enter experimental results via input module 128, and this functionality may be accomplished in at least two ways. For example, a user may copy and paste a gene sequence or other information into a text field of input module 128. Alternatively, a user may upload results from a networked scientific instrument, such as an expression array analyzer. In these types of cases, it is envisioned that alias extraction module 132 may be adapted to extract aliases from experimental results. In the case of a gene sequence, for example, an array recording the gene sequence may have pointers from gene sequence locations to aliases and/or core concepts in a gene lexicon. In the latter case, the gene sequences in the array may be viewed as aliases for the indicated core concepts.

Extracted aliases 134 may be processed by core concept identification module 136 to identify candidate core concepts 138 matching extracted aliases 134 in the user-selected lexica as indicated by selections 122 with respect to focused lexica 110. In some embodiments, users can browse contents of one or more of the lexica and select core concepts during navigation. The user may review the aliases of concepts that may be of interest and navigate a hierarchy associated with a lexicon/ontology as part of the core concept selection process. The candidate core concepts 138 may be communicated to the user via final selection module 140 of the user interface. Then, the user may select one or more of the candidate core concepts to arrive at core concept selections 142. In some embodiments, the user interface may also present selectable depths of link to the user via link depth selection module 144. The user may therefore specify a depth of link 146 between the selected core concepts that the user wishes to view.

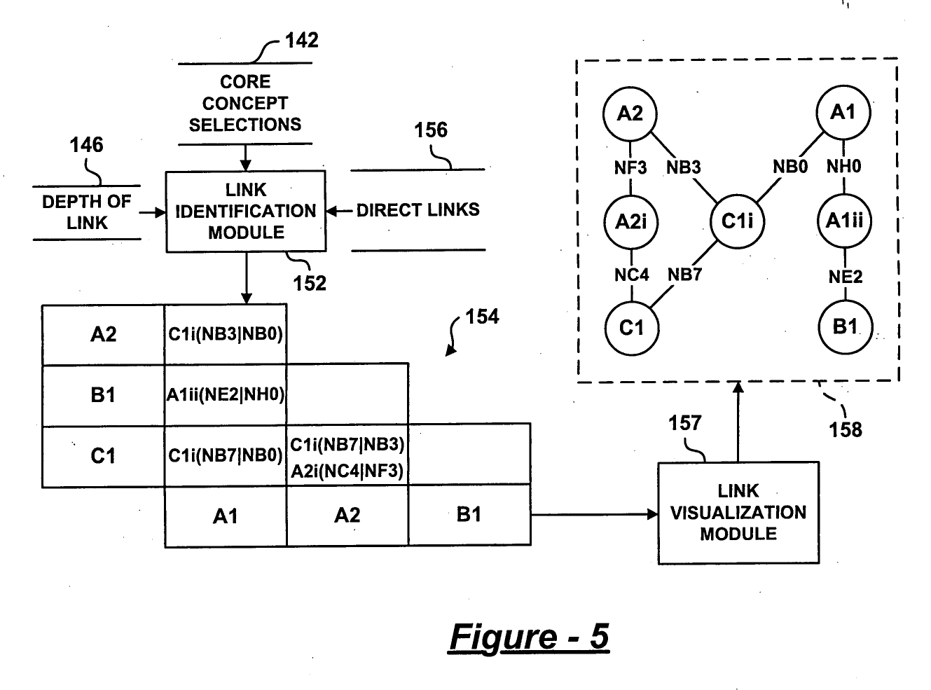

Once search system 116 (FIG. 1) has received initial search terms 130 from the user, communicated candidate core concepts 138 to the user, and received core concept selections 142 and depth of link 146 from the user, the task remains to communicate indirect links 148 and pointers to link-related literature 150 to the user. As illustrated in FIG. 5, some embodiments of the search system may employ link identification module 152 to assist in this task by generating a matrix 154 correlating each user-selected core concept to every other user-selected core concept or, alternatively, to concepts in a different focused lexicon, selected by the user. Module 152 may therefore populate the axes of matrix 154 with core concept selections 142, and populate the cells of matrix 154 with information about links of the specified depth of link 146 between each combinatorial pair of selected core concepts. Module 152 may obtain this information based on direct links 156, which may correspond to matrix 114 (FIG. 3) in some embodiments. Accordingly, matrix traversal algorithms may be employed to extract the required information based on the depth of link. For example, it may only be necessary to look in each cell of matrix 114 that is associated with each combinatorial pair of selected core concepts to find direct links of depth zero. Also, for indirect links of depth one, it may only be necessary to traverse each column and row for each combinatorial pair along the lower and left axes of matrix 114, and compare nodes of direct links to find shared nodes. For example, finding a level one indirect link between core concepts C1 and A2 may include locating the two core concepts along the lower axis. Then, moving progressively upwards to row B, a link may be found through shared, internal node C1i via direct links PB3 and PB7. Similarly, direct links PC4 and PF3 reveal a shared, internal node A2i at a depth of one. Further, indirect links of depth two may require that the matrix 114 be traversed to initially identify first-tier, internal nodes to which a combinatorial pair of specified core concepts directly link. Then, a further traversal may identify second-tier, internal nodes to which the first-tier, internal nodes directly link. Identical first-tier and second-tier nodes may then identify a level two indirect link between the pair of core concepts.

It is envisioned that similar procedures to those detailed above may be employed for links of various depths. For example, links of any depth may be identified by tracing each directed path of the specified depth through the threaded graph leading away from each user-specified edge node. Each non-circular path so identified may be stored in a stack, array, or equivalent data structure as a sequence of nodes, sequence of edges, or both. Then, each path for each specified edge node can be taken in turn and compared to each path of a recursively reducing set of other specified edge nodes. If a match is found in reverse order, then a link may be identified between the specified edge nodes. Equivalently, each edge node can be compared to the last element of node containing data structures to find a match. Alternative algorithms for identifying indirect links between user-specified edge nodes will become readily apparent to those skilled in the art given the preceding disclosure.

Some embodiments may only support finding of indirect links up to a depth of one or two to minimize complexity and facilitate visualization of the links, and some embodiments may allow only one depth to be specified at a time for the same reasons. It is also envisioned, however, that a depth range may be specified, and that links of all depths within the range may be identified and communicated to the user. Such a process may be facilitated by identifying links of greater depth first. Then, links of lesser depth that are not redundant with links of greater depth may be identified in order of diminishing depth. Given the preceding disclosure, equivalent procedures that accomplish identification of indirect links between edge nodes will be readily apparent to those skilled in the art, and direct links through one or more shared nodes may therefore be identified in many ways.

With links of the specified depth identified as detailed above, the appropriate cell of matrix 154 (FIG. 5) may be populated with information about the direct links that form the indirect links of the specified depth. In some embodiments, the number of pointers to documents supporting each direct link may be displayed in the cell in an order corresponding to the order in which the direct links form the indirect link. As a result, the direct links may be connected through shared nodes to form an indirect link. It is envisioned that matrix 154 may equivalently be populated with the P values of the direct links and/or the shared, internal nodes by which the direct links are bounded. It is also, envisioned that other techniques that accomplish link connection may be employed. For example, production of data structures recording paths through the threaded graph structure between nodes equivalently accomplishes connection. Also, recordation of direct links in combination with an algorithm capable of identifying the indirect links based on the direct links equivalently accomplishes connection. It is equivalently possible to identify all of the connections of various depths ahead of time and record them for faster access. Thus, identification of direct links is thus based on connection of direct links through at least one core concept not identified by a user, and may not entail a traversal of the direct links every time a user inputs a new query to the system. Such a pre-identification procedure may take place periodically either online or offline, and such services may be butsourced in some embodiments. In other embodiments, input queries may be received from various users and the results cached for reuse.

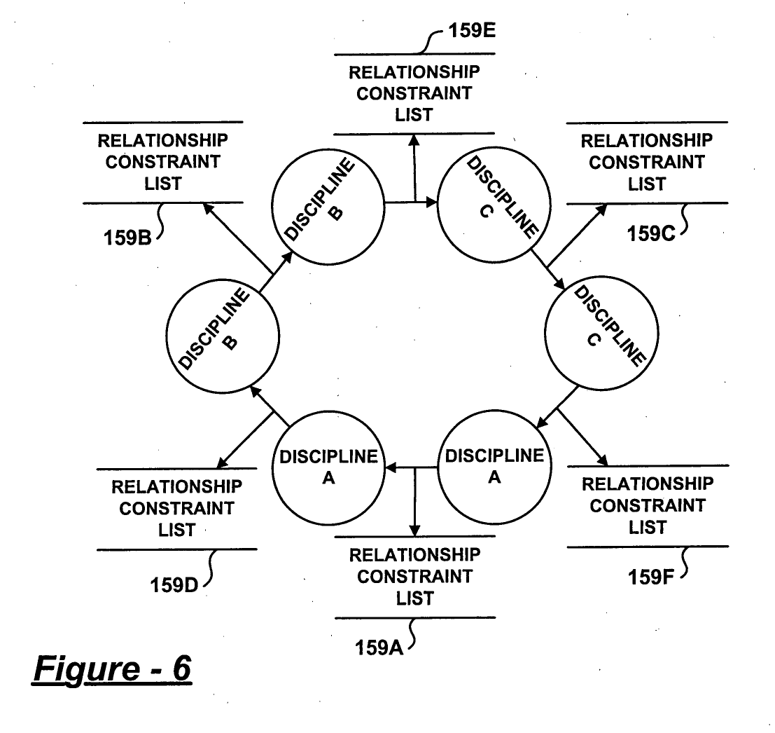

With cells of matrix 114 populated with information on the links between the user-specified core concepts, the task remains to communicate the information to the user. Accordingly, matrix 114 may be visually rendered in matrix form to the user, with matrix components serving as hyperlinks to associated data, such as core concepts and/or groups of pointers. Alternatively or additionally, link visualization module 157 may visually render the data resident in matrix 154 and/or matrix 114 (FIG. 3) on an active display in graph form as at 158 (FIG. 5). In so doing, module 157 may communicate the indirect links in the form of connected direct links rendered as edges of the graph that connect nodes corresponding to core concepts. It is envisioned that the edges and nodes may have visual characteristics communicating information about the core concepts and direct links. For example, the nodes may have labels, shapes, colors, and/or screen locations indicative of core concept type. Also, the edges may have labels, lengths, colors and/or thicknesses, indicative of relationship significance. Further, visual edge characteristics may communicate other information, such as relationship type and direction for the link. For example, as illustrated in FIG. 6, it is possible to develop constraint lists 159A-159F indicating types of potential relationships between nodes of various types. In some embodiments, node type may correspond to the discipline of the focused lexicon in which the core concept for the node is resident. However, it is envisioned that different node types may also reside within the same discipline. For example, a gene node and a protein node may both reside in a gene/protein lexicon ontologically organized by gene function, protein function, gene structure, and protein structure, with genes and proteins as leaves of the acyclic, directed graph formed by the lexicon.

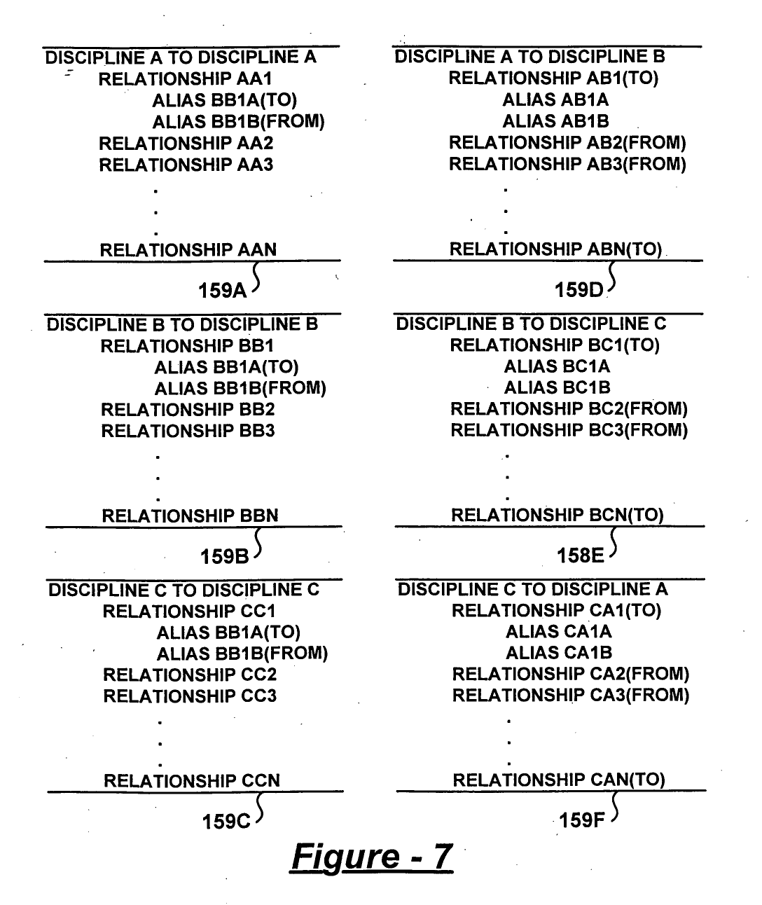

For each direct link between nodes, it may be possible to identify a corresponding constraint list for the link using predefined types of the bounding nodes as constraints. As illustrated in FIG. 7, each constraint list 159A-159F may include relationships and aliases for the relationships. Link identification module 102 (FIG. 1) may be adapted accordingly to automatically identify relationship aliases of the constraint list in contents of documents that support the link. Module 102 may also be adapted to look in proximity to a detected co-occurrence for the alias, which may be a word, phrase, or Boolean query. Given a large amount of documents supporting the link, it is reasonable to expect that one of the candidate relationships of the list will obtain a vastly greater number of hits in the related document contents than the other candidate relationships, and the candidate relationship may thereby be identified for the link.

Relationships may also have directions that, in many cases, may be evident from the type of relationship and the types of core concepts. Therefore, relationships may have predefined directions, especially where node type is not identical. Identical node type, however, makes it more difficult to identify a direction for the link. For example, it is easy to infer that a particular drug is used to treat a particular disease or that a particular gene produces a particular protein. It is more difficult, however, to determine which of two genes up-regulates the other. One way to identify a direction in such cases is to employ a semantic template when searching document contents for the relationship type. Another way is to track occurrences of a passive voice alias having a predefined direction versus occurrences of a corresponding active voice alias having an opposite, predefined direction. These occurrences may be categorized in relation to an order in which the core concepts occur in document contents, and a direction of the relationship may be determined from this information. In any case, even in an instance where a relationship or direction cannot be determined automatically in a reliable fashion, it is still possible to let the user determine the relationship and/or direction by browsing the related literature.

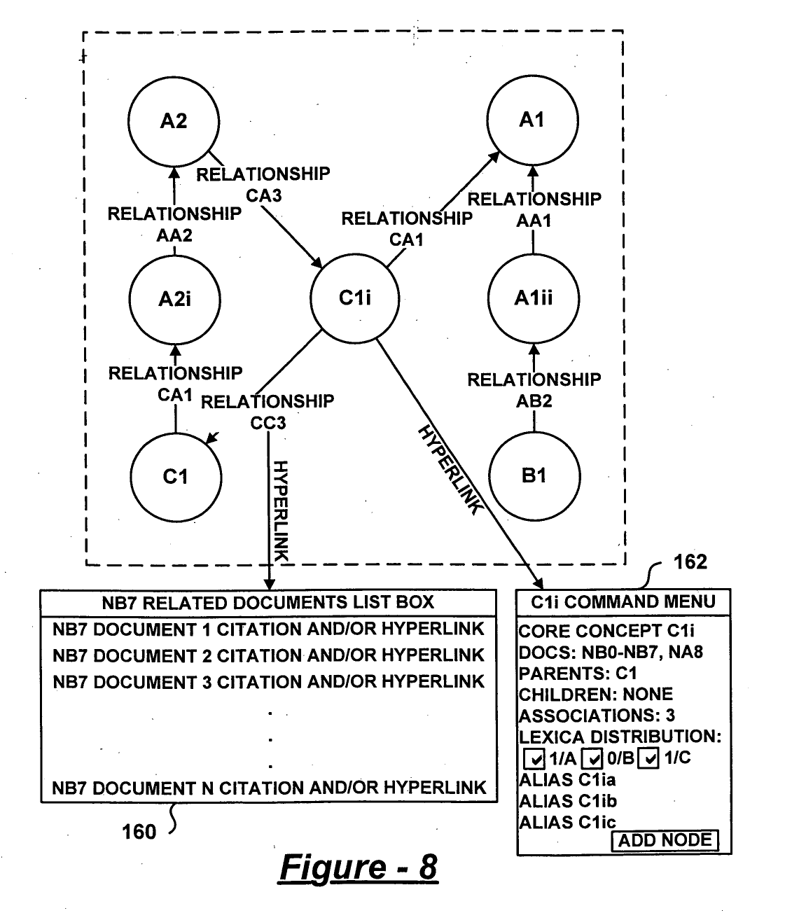

FIG. 8 illustrates hyperlink functionality of visually rendered concept relationship graph components. Edges of the graph serve as hyperlinks to document contents which support the corresponding links. Thus, even where a relationship has been automatically identified and visually displayed with the addition of an arrow head and a text label, the underlying support may be explored by a user by merely clicking on the edge in question or otherwise identifying a specific edge. This click then brings up a pointer output 160 delivering pointers to documents relating to the link. According to various embodiments, these pointers may correspond to bibliographic citations and/or hyperlinks to the documents. In some embodiments, clicking on or otherwise identifying a pointer may deliver the electronic document with aliases of the core concepts and/or relationships highlighted for the user. Similarly, a node of the graph may serve as a hyperlink to a concept summary output 162 delivering a summary of information about the associated core concept. For example, the core concept may be identified, along with hyperlinks to pointers to all documents of the literature corpus in which the core concept is located. Also, numbers of parent and child core concepts in the lexicon may be identified to the user. Further, the number of direct links to other concepts may be identified, and distribution among the selectable lexica of these associations may be indicated. Yet further, an interface for altering the lexica selections may be provided in proximity to this indication of association distribution to facilitate user ability to alter these selections for subsequent searches. Further still, aliases of the core concept may be identified. Finally, a command button may provide the user with one or more abilities. For example, an ability to add an internal node to the search set of edge nodes may be provided so that more indirect relationships of the specified depth can be quickly identified between that node and other edge nodes of the graph in a subsequent search. Similarly, an edge node may be removed from the search set of edge nodes. As a result, a user may directly specify core concepts by clicking on a graph node. Further, a command button or related mode of operation may provide an ability to re-center on a selected node. A browsing function is therefore provided that can illustrate curated and automatically detected links of a specified depth or range of depths between core concepts. Curated links may be identified as such, and users may jump through a pre-computed concept map, re-centering it on new concepts as they go, without having to look at the documents until interesting relationships or concepts are found. It is envisioned that users may similarly be allowed to browse lexica and add and remove core concepts from a search set at will. It is also envisioned that the depth of link may be altered by the user when running a subsequent search.

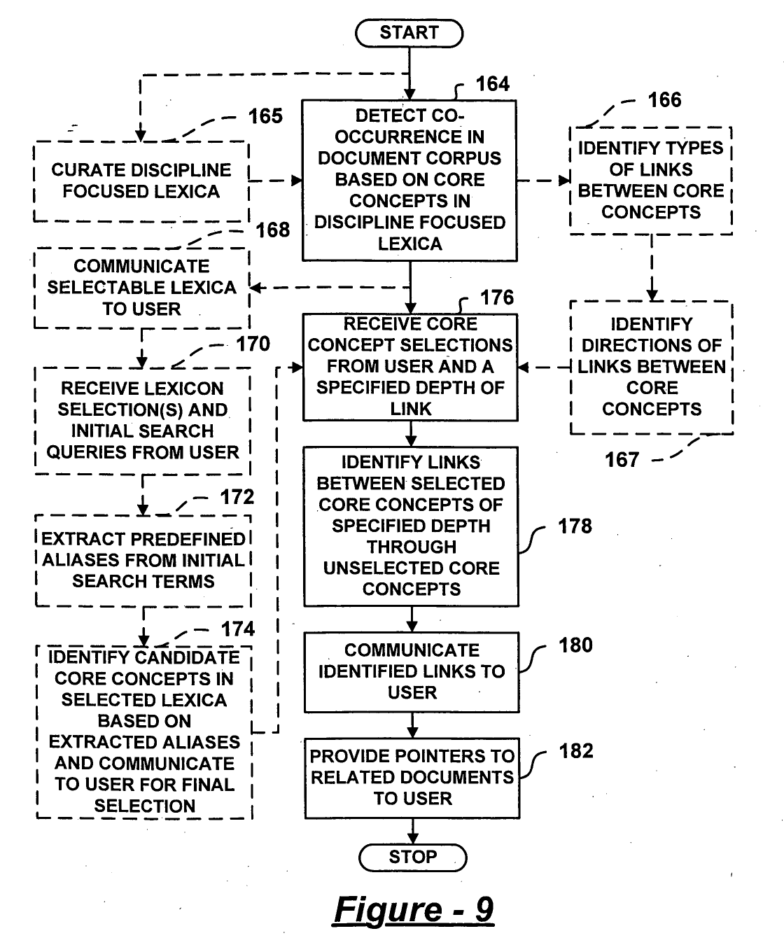

FIG. 9 illustrates the method of information retrieval and document navigation followed by the literature pipeline. For example, direct links may be found between pre-defined core concepts observed in a document corpus at step 164. Step 164 may include detecting co-occurrence by employing a mutual information technique such as the Fisher exact test to obtain a statistical P value expressing a significance of a detected co-occurrence. Step 164 may further include employing multiple, discipline-focused lexica organized according to the core concepts, wherein the lexica identify aliases by which the core concepts may be found in document contents. Step 164 may further include identifying an alias of a core concept in document contents and equating occurrence of the alias with occurrence of the core concept. Step 164 may further include maintaining pointers between direct links and documents in which the direct links are found.

The lexica that may be employed in step 164 may be curated in advance in step 165. Step 165 may include focusing the lexica toward research disciplines, such as gene, disease, drug, tissue, and taxonomy. For example, a gene lexicon may be organized according to core concepts corresponding to gene functions, protein functions, gene names, protein names, gene structures, and protein structures. Step 165 may further include identifying multiple aliases for a core concept by which the core concept may be identified in a documents corpus, and selecting one alias as a preferred alias. Aliases may correspond to words, phrases, Boolean search strings, semantic templates, gene sequences, protein sequences, ID numbers, accession numbers and other searchable terms.

According to some embodiments, a type of a link between two core concepts may be identified at step 166 based on automatic detection in link-related document contents of one of plural, predefined, candidate relationships between predefined categories associated with the two core concepts. Example types of relationships include “is a”, “part of”, and “tributary of”. Similarly, step 167 may include automatically identifying a direction of a link between two core concepts based on a type of the link between the two core concepts and predefined categories associated with the two core concepts. Steps 166 and 167 may include selecting a constraint list of candidate relationship types based on predefined categories associated with two core concepts bounding a direct link. Accordingly, step 166 may include automatically identifying a type of relationship associated with the direct link by finding occurrences of constraint list elements in proximity to detected co-occurrences of the two core concepts in document contents supporting the direct link. In the case of two core concepts of different predefined categories, step 167 may include applying a predefined direction associated with a candidate relationship to a direct link bounded by the two core concepts. In the case of two core concepts of identical predefined categories, step 167 may include matching a semantic template associated with a candidate relationship to document contents in proximity to detected co-occurrences of the two core concepts in document contents supporting the direct link. Thus, step 164 may accomplish construction of a database of direct links between core concepts. Addition of steps 166 and 167 may enhance this database with automatically identified directions and relationships appropriate to predefined categories of linked core concepts. As a result, a database of directional links between core concepts forms an extendable, searchable, concept map that supplements manually curated links and supporting documents.

Following construction of a direct link database in step 164, a user interface technique may be employed that may include communicating selectable lexica to a user at step 168. Then, the technique may further include receiving lexicon selections and initial search terms from the user at step 170. Step 170 may include receiving a gene sequence or other experimental results from a user or networked research instrument of the user. Then, the technique may further include extracting predefined aliases from initial search terms at step 172 with reference to the selected lexica, and identifying candidate core concepts in lexica selected by the user based on the extracted aliases at step 174. Step 174 may further include communicating the candidate core concepts to the user for final selection.

The method may include receiving core concept selections and a specified depth of link from a user at step 176. Step 176 may include receiving final selections of core concepts from a user. Step 176 may also include receiving initial core concept selections from a user viewing a graph of links or browsing lexica. Further, receipt of the specified depth of link from the user in step 176 is optional, and a predetermined depth or range of depths may be employed.

Following step 176, indirect links are identified between core concepts selected by a user at step 178. Step 176 may include connecting direct links through at least one core concept not selected by the user. Step 176 may further include constructing a matrix correlating the selected core concepts to one another and populating cells of the matrix with information relating to indirect links of one or more predetermined depths. Step 176 may include employing one or more algorithms to follow non-circular paths originating at selected core concepts in the direct link database. These algorithms may compare paths originating at different core concepts to find an indirect link based on an inverted match between paths. Alternatively, these algorithms may identify an indirect link by detecting presence of a selected core concept at the end of a path originating at another selected core concept. These algorithms may connect direct links forming an indirect link by recording information about a path between selected core concepts in memory.

Information about identified links is communicated to the user at step 180, which may include displaying a matrix constructed in step 178 to the user. Step 180 may additionally or alternatively include rendering a graphic display of links between core concepts, with nodes corresponding to core concepts and edges corresponding to links. Edges between bounding nodes representing core concepts may have visual characteristics identifying a strength of relationship, a type of relationship, and a direction of relationship. Similarly, nodes representing core concepts may have visual characteristics identifying a predefined category or a name of the core concept. Visual characteristics may be node shapes, edge thicknesses, colors, text labels, locations, arrow heads, and other types of visual indicators.

Pointers to documents supporting links are provided to the user at step 182. Accordingly, a graphic display of links between core concepts, may have nodes serving as hyper links to summaries of information relating to associated core concepts, and edges serving as hyperlinks to collections of pointers to documents supporting associated links. Pointers may be in a citation format, and/or may serve as hyperlinks to the documents in electronic form. Hyperlink pointers may point to locations in document contents where aliases of core concepts and/or relationships occur. Therefore, display of the documents may include highlighting occurrences of aliases in the documents.

Those skilled in the art can now appreciate from the foregoing description that these broad teachings can be implemented in a variety of forms. Therefore, while the literature pipeline has been described in connection with particular examples thereof, the true scope thereof should not be so limited since other modifications will become apparent to the skilled practitioner upon a study of the drawings, the specification and the following claims.

1. An information retrieval and document navigation system, comprising:
a datastore of direct links between pre-defined core concepts found in a document corpus;
a link identification module adapted to identify indirect links between core concepts selected by a user based on connection of direct links through at least one core concept not selected by the user; and
an output adapted to communicate identified links to the user.

2. The system of claim 1, further comprising a co-occurrence detection module finding the direct links by detecting co-occurrence between core concepts in the document corpus and employing a mutual information technique including the Fisher exact test to obtain a statistical P value expressing a significance of a detected co-occurrence.

3. The system of claim 2, wherein said co-occurrence detection module is adapted to identify an alias of a core concept in document contents, and to equate occurrence of the alias with occurrence of the core concept.

4. The system of claim 1, wherein said datastore further maintains pointers between detected co-occurrences and documents in which the co-occurrences are detected.

5. The system of claim 1, Wherein said output is adapted to provide pointers to documents to the user, wherein the documents relate to an identified link.

6. The system of claim 1, further comprising multiple, discipline-focused lexica organized according to the core concepts and identifying aliases by which the core concepts may be found in document contents.

7. The system of claim 1, further comprising a user interface adapted to communicate selectable lexica to the user, to receive lexicon selections and initial search terms from the user, to extract aliases from the initial search terms, to identify candidate core concepts in lexica selected by the user based on the extracted aliases, and to communicate the candidate core concepts to the user for final selection.

8. The system of claim 1, further comprising an input receiving core concept selections and a specified depth of link from a user.

9. The system of claim 1, wherein said datastore is adapted to record a type of a link between two core concepts, wherein the type of link is automatically identified based on automatic detection in link-related document contents of one of plural, predefined, candidate relationships between predefined categories associated with the two core concepts.

10. The system of claim 1, wherein said datastore is adapted to record a direction of a link between two core concepts, wherein the direction of the link is automatically determined based on a type of the link between the two core concepts and predefined categories associated with the two core concepts.

11. The system of claim 1, wherein said output is adapted to communicate identified links to the user in the form of a matrix relating core concepts to core concepts.

12. The system of claim 1, further comprising a browsable lexicon of core concepts permitting the user to browse core concepts according to relationships between the core concepts and to select core concepts.

13. The system of claim 1, further comprising a pre-computed link datastore containing directional links between core concepts forming an extendable, searchable concept map in addition to manually curated links and supporting documents.

14. The system of claim 1, further comprising a datastore of curated relationships and automatically detected relationships between core concepts, wherein said output is adapted to at least one of:
(a) identify curated relationships as curated; and
(b) identify only curated relationships associated with a core concept based on user preference.

15. The system of claim 1, a plurality of links between biological sequence data and related documents in the document corpus.

16. An information retrieval and document navigation system, comprising:
multiple, discipline-focused lexica organized according to core concepts and identifying aliases by which the core concepts may be found in document contents;
a datastore of direct links between pre-defined core concepts found in a document corpus, wherein said datastore further maintains pointers between detected co-occurrences and documents in which the co-occurrences are detected;
a co-occurrence detection module finding the direct links by detecting co-occurrence between core concepts in the document corpus by employing a mutual information technique to obtain a level of statistical significance of a detected co-occurrence, wherein said co-occurrence detection module is adapted to identify an alias of a core concept in document contents, and to equate occurrence of the alias with occurrence of the core concept;
a link identification module adapted to identify indirect links between core concepts selected by a user based on connection of direct links through at least one core concept not selected by the user; and
an output adapted to communicate identified links and related pointers to documents supporting the identified links to the user.

17. The system of claim 16, wherein said output is adapted to render a graphic display of links between core concepts, with nodes corresponding to core concepts and edges corresponding to links.

18. The system of claim 17, wherein the nodes serve as hyperlinks to summaries of information relating to associated core concepts.

19. The system of claim 17, wherein the edges serve as hyperlinks to collections of pointers to documents supporting associated links.

20. The system of claim 17, wherein the edges have visual characteristics identifying at least one of a strength of relationship between bounding nodes, a type of relationship between bounding nodes, and a direction of relationship between bounding nodes.

21. The system of claim 16, further comprising a link relation module adapted to select a constraint list of candidate relationship types based on predefined categories associated with two core concepts bounding a direct link, and to automatically identify a type of relationship associated with the direct link by finding occurrences of constraint list elements in proximity to detected co-occurrences of the two core concepts in document contents supporting the direct link.

22. The system of claim 21, wherein the two core concepts are of different predefined categories, the candidate relationship types have a predefined direction between the two core concepts, and said link relation module is adapted to apply the predefined direction of the type of relationship associated with the direct link to the direct link.

23. The system of claim 21, wherein the two core concepts are of identical predefined categories, the candidate relationship types have predefined semantic templates adapted to identify directions between the two core concepts in document contents supporting the direct link, and said link relation module is adapted to automatically identify a direction associated with the direct link by matching a template of the type of relationship associated with the direct link to document contents in proximity to detected co-occurrences of the two core concepts in document contents supporting the direct link.

24. The system of claim 16, wherein said multiple, discipline-focused lexica include a gene lexicon organized according to core concepts corresponding to at least one of gene functions, protein functions, gene names, protein names, gene structures, and protein structures.

25. The system of claim 24, wherein said multiple, discipline-focused lexica include a disease lexicon, a drug lexicon, a tissue lexicon, and a taxonomy lexicon.

26. The system of claim 16, wherein the mutual information technique includes the Fisher exact test.

27. A method of information retrieval and document navigation, comprising:
finding direct links between pre-defined core concepts in a document corpus;
identifying indirect links between core concepts selected by a user based on connection of direct links through at least one core concept not selected by the user; and
communicating identified links to the user.

28. The method of claim 27, wherein said finding direct links includes detecting co-occurrence by employing a mutual information technique including the Fisher exact test to obtain a statistical P value expressing a significance of a detected co-occurrence.

29. The method of claim 27, wherein said finding direct links includes:
identifying an alias of a core concept in document contents; and
equating occurrence of the alias with occurrence of the core concept.

30. The method of claim 27, further comprising maintaining pointers between direct links and documents in which the direct links are found.

31. The method of claim 27, further comprising providing pointers to documents to the user, wherein the documents relate to an identified link.

32. The method of claim 27, wherein said finding direct links includes employing multiple, discipline-focused lexica organized according to the core concepts and identifying aliases by which the core concepts may be found in document contents.

33. The method of claim 27, further comprising:
communicating selectable lexica to the user;
receiving lexicon selections and initial search terms from the user;
extracting aliases from the initial search terms;
identifying candidate core concepts in lexica selected by the user based on the extracted aliases; and
communicating the candidate core concepts to the user for final selection.

34. The method of claim 27, further comprising receiving core concept selections and a specified depth of link from a user.

35. The method of claim 27, further comprising automatically identifying a type of a link between two core concepts based on automatic detection in link-related document contents of one of plural, predefined, candidate relationships between predefined categories associated with the two core concepts.

36. The method of claim 27, further comprising automatically identifying a direction of a link between two core concepts based on a type of the link between the two core concepts and predefined categories associated with the two core concepts.

37. The method of claim 27, further comprising rendering a graphic display of links between core concepts, with nodes corresponding to core concepts and edges corresponding to links.

38. The method of claim 27, further comprising rendering a graphic display of links between core concepts, wherein nodes serve as hyper links to summaries of information relating to associated core concepts, and edges serve as hyperlinks to collections of pointers to documents supporting associated links.

39. The method of claim 27, further comprising rendering a graphic display of links between core concepts, wherein edges between bounding nodes representing core concepts have visual characteristics identifying at least one of a strength of relationship between bounding nodes, a type of relationship between bounding nodes, and a direction of relationship between bounding nodes.

40. The method of claim 27, further comprising:
selecting a constraint list of candidate relationship types based on predefined categories associated with two core concepts bounding a direct link; and
automatically identifying a type of relationship associated with the direct link by finding occurrences of constraint list elements in proximity to detected co-occurrences of the two core concepts in document contents supporting the direct link.

41. The method of claim 27, further comprising applying a predefined direction associated with a candidate relationship between two core concepts of different predefined categories to a direct link bounded by the two core concepts.

42. The method of claim 27, further comprising automatically identifying a direction associated with a direct link between two core concepts of an identical type by matching a semantic template associated with a candidate relationship between the two core concepts to document contents in proximity to detected co-occurrences of the two core concepts in document contents supporting the direct link.

43. The method of claim 27, further comprising employing a gene lexicon organized according to core concepts corresponding to at least one of gene functions, protein functions, gene names, protein names, gene structures, and protein structures.

44. The method of claim 27, further comprising employing multiple, discipline-focused lexica organized according to core concepts pertaining to respective research disciples, including employing a gene lexicon, a disease lexicon, a drug lexicon, a tissue lexicon, and a taxonomy lexicon.
